(19) United States
(12) Patent Application Publication
(10) Pub. No.: US 2007/0022288 A1
(43) Pub. Date: Jan. 25, 2007

(54) Checking of a digital quantity stored in a memory area

(75) Inventors: Yannick Teglia, Marseille (FR); Pierre-Yvan Liardet, Peynier (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 11/481,211

(22) Filed: Jul. 5, 2006

(30) Foreign Application Priority Data
Jul. 5, 2005 (FR) 0552048

(51) Int. Cl. H04L 9/00

(52) U.S. Cl. 713/165; 380/247

(57) ABSTRACT

A method for checking a digital quantity contained in a non-volatile storage element of a processor and such a processor, including dividing the block into blocks of identical size, applying a symmetrical ciphering algorithm to each block, and applying a non-linear bijective function to results of the previous steps to obtain a current value to be compared with an expected value provided by the outside of the processor.

### BACKGROUND OF THE INVENTION

1. Field of the Invention

The present invention generally relates to mechanisms for checking the integrity of digital quantities stored in a memory area of an electronic circuit. Such mechanisms are used to check whether a digital quantity has not been incidentally or voluntarily modified since its recording.

The present invention more specifically relates to the case of quantities representing at least partially an authentication key of a secondary processor for use thereof by an electronic device containing a main processor.

An example of application of the present invention relates to multimedia processors intended for mobile telephony (GSM).

2. Discussion of the Related Art

FIG. 1 is a schematic block diagram of an example of an integrated processor 1 of the type to which the present invention applies. Such a processor comprises, among others, a central processing unit 2 (CPU), a first memory 31 of non-volatile type (for example, a ROM) containing at least programs, a second non-volatile memory 32 (for example, a PROM) of a size smaller than the first one, a volatile memory 4 (MEM) for the execution of the programs stored in memory 31, and an input/output element 5 (I/O) for communicating with or without contact with the outside of the processor. The elements internal to processor 1 communicate by means of several data, address, and control buses 6. Other elements (for example, multimedia processing circuits) are generally comprised in circuit 1.

A processor 1 to which the present invention applies generally contains, in non-volatile memory 32 (for example, an antifuse or PROM area), a digital quantity having at least a portion intended to remain unknown from the outside of the processor (secret). Such a quantity is used, for example, to authenticate the processor to provide it access to applications of the electronic device in which it is placed, or is used to cipher exchanges between the electronic device and the outside, the ciphering mechanisms being integrated in circuit 1.

FIG. 2 very schematically shows in the form of blocks an example of an electronic device 10 (MAIN DEV), for example, a GSM-type mobile processor, containing a processor 1 (SEC PROC). Device 10 comprises at least one main processor 11 (M PROC) communicating over data, address, and control buses 16 with at least secondary processor 1, a memory 14 (MEM), a transceiver system 15 (T/R), a display system 17 (SCR), and other peripherals 18 (PER). For simplification, not all the elements of device 10 have been illustrated, the present invention relating to the checking of the integrity of a digital quantity contained in memory 32 (FIG. 1) of secondary processor 1.

Integrity check mechanisms generally use a calculation of a fingerprint or signature of the involved digital quantity and a comparison of this fingerprint with an expected value, stored in relation with an identifier (for example, a serial number) of the circuit containing the digital quantity.

FIG. 3 illustrates a conventional example of a mechanism for checking the integrity of a digital quantity contained in a processor SEC PROC by an electronic device MAIN DEV. For simplification, on the electronic device side, only main processor 12 and a file of memory 14 have been illustrated in FIG. 3. Memory 14 contains, for authentication purposes, a table of identifiers (ID) of the different secondary processors and the expected corresponding fingerprint or digital signature values (CRC). As a variation, this table is contained in a remote system with which the electronic device communicates, for example, via the GSM network. On the side of processor 1, a digital quantity SKEY contained in non-volatile memory 32 is used by central processing unit 2 to calculate a parity or CRC-type (Cyclic Redundancy Check) fingerprint. The secondary processor communicates its identifier ID to the main device which returns an expected value of the fingerprint (CRC) thereto. Central processing unit 2 internally calculates the CRC corresponding to quantity SKEY, then compares the two values of the fingerprint.

A problem is that knowing the actual fingerprint must not enable a possible hacker to go back to the secret quantity. Now, such is currently the case for CRC calculation or parity control functions. The larger the word resulting from the CRC, the more information it gives about the original digital quantity. In other words, the more it decreases the effective size of the quantity supposed to remain secret.

A first solution would be to store the fingerprint in the secondary processor and to check it therein (the value expected for comparison being provided by the external device). A disadvantage however is that the non-volatile storage of the fingerprint in the secondary processor takes space. Now, it cannot be envisaged to store this value in ROM 31 on manufacturing since it must be individualized per circuit.

In an example of application to multimedia processors for mobile phones, a 192-bit digital quantity is stored in an area of a non-volatile memory programmable after manufacturing (PROM), among which 64 bits are key bits. The low non-volatile storage capacity of this area forbids in practice the storage of a parity control or CRC-type fingerprint.

A second solution would be to use a fingerprint calculation algorithm, the result of which provides no information about the original quantity, to be able to provide this fingerprint to the external device for checking. Such would be for example the case for a hash function such as that known as SHA-1.

A disadvantage is the time taken by such a calculation.

Another disadvantage is that the processors to which the present invention applies generally do not have enough space in the non-volatile memory programmable after manufacturing (PROM) to store the result of an integrity calculation more complex than a CRC calculation.

Another problem is that the calculation of the fingerprint used for the integrity check must not enable a possible hacker to discover the digital quantity or at least its portion supposed to remain secret. It can thus not be envisaged to provide in clear the secret quantity to the external electronic device.

### SUMMARY OF THE INVENTION

The present invention aims at overcoming all or part of the disadvantages of methods for checking the integrity of a digital quantity contained in a processor and representing at least partly a quantity supposed to remain unknown from the outside of this processor.

The present invention more specifically aims at avoiding non-volatile storage in the processor of a fingerprint resulting from an integrity calculation.

The present invention also aims at providing a solution enabling using fingerprint calculation algorithms providing no information about the original digital quantity.

The present invention also aims at a solution to authenticate a secondary processor in an electronic device.

To achieve all or part of these objects, as well as others, the present invention provides a method for checking a digital quantity contained in a non-volatile storage element of a processor, comprising the steps of:

dividing said block into blocks of identical size;

applying a symmetrical ciphering algorithm to each block; and

applying a non-linear bijective function to the result of the previous steps to obtain a current value to be compared with an expected value provided by the outside of the processor.

According to an embodiment of the present invention, each block, starting from the second one, is, before applying the ciphering algorithm, combined with the result provided by the ciphering algorithm from the previous block, the first block being combined with an initialization vector.

According to an embodiment of the present invention, said expected value is provided by an element of an electronic device containing said processor, the result of the comparison being provided to this device as indicating an authentication of the processor with no transmission of the digital quantity.

According to an embodiment of the present invention, a folding function comes before the application of the non-linear bijective function.

According to an embodiment of the present invention, the digital quantity is surrounded with two given bit blocks.

According to an embodiment of the present invention, the key of the ciphering algorithm is public, said block completing the digital quantity on the least-significant bit side being selected randomly.

According to an embodiment of the present invention, the used symmetrical ciphering algorithm takes into account any initialization vector and processes said digital quantity as a data block.

According to an embodiment of the present invention, the ciphering algorithm is a DES algorithm, only four turns of which are performed.

The present invention also provides an integrated processor and a mobile phone.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1, previously described, very schematically shows in the form of blocks an example of an integrated processor of the type to which the present invention applies;

FIG. 2, previously described, very schematically shows in the form of blocks an example of an electronic device of the type to which the present invention applies;

FIG. 3, previously described, is intended to show the state of the art and the problem to solve;

FIG. 4 very schematically shows in the form of blocks an embodiment of the integrity check method according to the present invention;

FIG. 5 very schematically shows in the form of blocks an embodiment of a step of the method of FIG. 4; and

FIG. 6 illustrates an example of authentication of a secondary processor by an electronic device implementing the integrity check method of the present invention.

### DETAILED DESCRIPTION

The same elements have been designated with the same reference numerals in the different drawings. For clarity, only those steps and elements which are useful to the understanding of the present invention have been shown in the drawings and will be described hereafter. In particular, the functions implemented by the processor authenticated by the present invention have not been described in detail, the present invention being compatible with any conventional application of a microprocessor. Further, the exploitation that is made of the integrity check for authentication or other purposes has not been described in detail, the present invention being here again compatible with any conventional exploitation of an integrity check.

A feature of an embodiment of the present invention is to apply a message authentication code (MAC) calculation by using a symmetrical ciphering algorithm and by using the digital quantity, the integrity of which is desired to be checked, as an input word. Generally, a symmetrical algorithm uses a key and an initialization vector to cipher an input word. The present invention provides applying the symmetrical algorithm to the digital quantity containing a secret portion. The key of the algorithm and the initialization vector may, according to the present invention, may be any and unprotected. In particular, the key may be public.

Another feature of an embodiment of the present invention is to have the MAC calculation followed with a non-linear bijective function.

The advantage of a MAC is that, knowing the result, it is very difficult for a hacker to find the input data (here, the digital quantity having at last a portion that must remain unknown from the outside). The advantage of having it followed by a non-linear bijective function is that this makes the final obtained fingerprint irreversible by inverse calculation.

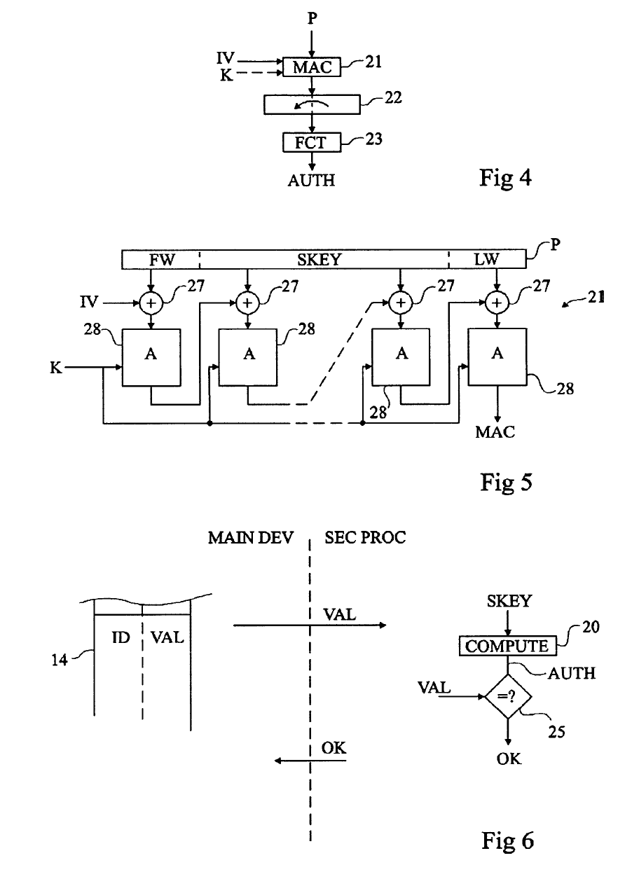

FIG. 4 very schematically illustrates in the form of blocks an example of application of the fingerprint calculation method according to the present invention.

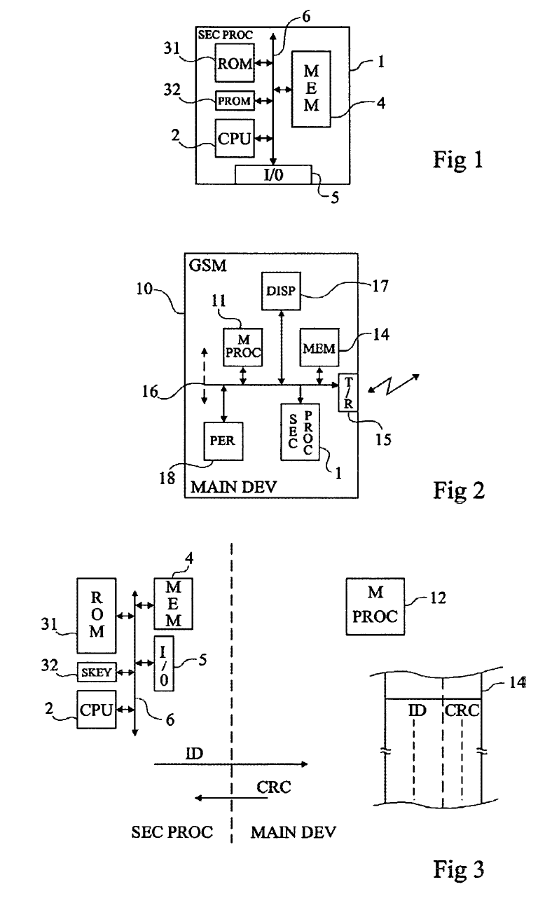

The case of a secondary processor 1 of the type previously described in relation with FIG. 1 intended to be authenticated for use by an electronic device 10 of the type previously described in relation in relation with FIG. 2, is assumed.

The fingerprint calculation can be divided into three steps.

A first step (block 21, MAC) comprises a message authentication code calculation by using, as data, digital quantity SKEY of the secondary processor having at least a portion which is supposed to remain unknown from the outside of the circuit 1, an initialization vector IV, and a key K, for example, public.

FIG. 5 shows an example of implementation of calculation 21 of the MAC code from digital quantity SKEY, an initialization vector IV, and a key K.

A MAC calculation is performed by blocks (for example, of 32 bits). The MAC calculation comprises, for each block of a digital word P, the performing of an XOR-type combination (block 27), which amounts to a bit-to-bit addition, with the result of the application of a ciphering algorithm (block 28, A) to the result of the combination of the previous block. Quantity SKEY representing at least one block is considered as input data of mechanism 21 of FIG. 5 and is completed at least by a first block FW (on the most significant bit side of quantity SKEY) and a last block LW (on the least significant bit side of quantity SKEY) to form a word P to be processed by mechanism 21. Thus, the introduction of the blocks of quantity SKEY is masked by being confined to the internal loops of the MAC calculation. First combination 27 uses initialization vector IV to combine it with block FW and the output of the last application of algorithm 28 provides result MAC, its input combining block LW with the output of the algorithm 28 of preceding rank. Each execution of the ciphering algorithm uses key K. If the initialization vector is public, block FW is, preferably, selected randomly. If key K is public, block LW is, preferably, selected randomly.

As an example, algorithm A is a DES-type algorithm, simplified in that it performs but a limited number of turns (for example, four), which is enough to stir the bits of the digital quantity.

An advantage of using a ciphering algorithm within a MAC-type function is that the processors to which the present invention applies generally comprises a hardware circuit executing such an algorithm. Such is especially the case for the DES in multimedia processors applied to mobile telephony products. The execution of the function is thus fast and requires no additional resources with respect to those available in the processor. Thus, the algorithm used by the present invention is preferentially selected from among the symmetrical ciphering algorithms available in the concerned processor.

According to the embodiment of the present invention illustrated in FIG. 4, result MAC is submitted (block 22) to a folding function comprising the folding of its left-hand portion over its right-hand portion. Such a folding amounts to applying an XOR-type combination of the bits of the right-hand portion with the bits of the left-hand portion, respectively. The result of the folding function which divides by two the number of bits is then submitted to a non-linear bijective function (block 23, FCT), the result of which provides a word AUTH representing the fingerprint of quantity SKEY. For example, function FCT is f(x)=x+(x² AND C), where C is a non-zero constant.

Preferably, function 23 is preceded with a forcing of at least any bit to state one of the folding result. Such a forcing ensures the bijectivity of the subsequent function 23 by avoiding introducing a zero into it, failing which there exists a risk of collision in the results AUTH provided for different quantities SKEY.

Functionally, the application of the MAC to quantity SKEY as data results in a diffusion-confusion algorithm (bit stirring), the folding function ensures the irreversibility of the calculation and the bijective non-linear function takes the irreversible character from a table which would put in relation the digital quantities and the fingerprints.

FIG. 6 very schematically illustrates, in a representation to be compared with that of FIG. 3, an example of implementation of the integrity checking according to the present invention.

When an authentication of secondary processor SEC PROC is required by main electronic device MAIN DEV, said device transmits a value VAL which is a function of identifier ID of the secondary processor and contained in a table 14 of the memory, as in the solution of FIG. 3. Value VAL forms the expected fingerprint if quantity SKEY is conformal to identifier ID of the processor. As for the secondary processor, it performs the calculation (block 20, COMPUTE) of fingerprint AUTH. This result is then compared (block 25, =?) with a value VAL provided by the electronic device to validate (OK) or not the integrity of quantity SKEY. Validation message OK is provided to electronic device MAIN DEV which exploits it, for example, to allow or not the different functions linked to the application of the secondary processor.

Other exchanges, not shown, may come before sending of value VAL, especially the provision, by secondary processor SEC PROC, of its identifier ID.

Value VAL is, for example, stored with identifier ID on personalization of device MAIN DEV, for example, in a publicly-accessible area. Indeed, it is not disturbing to make this value public since it divulgates by no means quantity SKEY. As a variation, the electronic device interrogates a remote system, for example, by using the GSM network in the application to multimedia processors for mobile phones, to obtain value VAL from identifier ID of the processor.

An advantage of the present invention is that it enables checking the integrity of a digital quantity without requiring storage of the fingerprint in the circuit containing this digital quantity, nor jeopardizing its being unknown from the outside of the circuit.

Another advantage of the present invention is that it takes advantage of existing calculation elements (especially ciphering algorithms) contained in the processor to be authenticated, which saves space in its non-volatile memory intended for programs.

Of course, the present invention is likely to have various alterations, improvements, and modifications which will readily occur to those skilled in the art. In particular, the practical implementation of the present invention based on software and/or hardware tools is within the abilities of those skilled in the art based on the functional indications given hereabove.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for checking a digital quantity contained in a non-volatile storage element of a processor, comprising:
dividing said block into blocks of identical size;
applying a symmetrical ciphering algorithm to each block; and
applying a non-linear bijective function to the result of the previous steps to obtain a current value to be compared with an expected value provided by the outside of the processor.

2. The method of claim 1, wherein each block, starting from the second one, is, before applying the ciphering algorithm, combined with the result provided by the ciphering algorithm from the previous block, the first block being combined with an initialization vector.

3. The method of claim 1, wherein said expected value is provided by an element of an electronic device containing said processor, the result of the comparison being provided to this device as indicating an authentication of the processor with no transmission of the digital quantity.

4. The method of claim 1, wherein a folding function is applied before the application of the non-linear bijective function.

5. The method of claim 1, wherein the digital quantity is surrounded with two given bit blocks.

6. The method of claim 5, wherein the key of the ciphering algorithm is public, said block completing the digital quantity on the least-significant bit side being selected randomly.

7. The method of claim 1, wherein the used symmetrical ciphering algorithm takes into account any initialization vector and processes said digital quantity as a data block.

8. The method of claim 1, wherein the ciphering algorithm is a DES algorithm, only four turns of which are performed.

9. An integrated processor, comprising means for implementing the method of claim 1.

10. A mobile phone, comprising the processor of claim 9.
